(19) United States
(12) Patent Application Publication
(10) Pub. No.: US 2007/0233685 A1
(43) Pub. Date: Oct. 4, 2007

(54) Displaying access rights on search results pages

(75) Inventors: Eric L. Burns, Seattle, WA (US); Jay R. Girotto, Kirkland, WA (US); Jon M. Buschman, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/394,098

(22) Filed: Mar. 31, 2006

(51) Int. Cl. G06F 17/30

(52) U.S. Cl. 707/9

(57) ABSTRACT

A system and method are provided for allowing authorized users to access search results containing protected content, and for indicating within a user interface which search results an affiliated institution has and does not have access to. The invention can be configured to identify which search results within a search results set are protected search results containing protected content versus search results that are freely available. The invention can associate the user with an institution that is authorized to access the protected search result and can allow the user to access the protected search result once the association has been verified.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND

Scholarly literature and other works that are published electronically sometimes require a subscription or some type of authentication in order to access the works. However, conventional search engines used to identify scholarly works typically do not indicate the type of access rights required for the particular work. This may require a user to spend additional time to determine whether or not he/she can access the scholarly literature. It may be desirable to have the search engine display information that can aid a user in identifying needed access rights. It may also be desirable to indicate the search results within a search results set that a searcher has access to and which results the searcher does not have access to in order to allow the user to efficiently perform their searching experience.

### SUMMARY

A system and method are provided for identifying protected content within a search results set that a requester is authorized to access. In an embodiment, a method can be configured to provide a search results set for a requester in which the search results set includes at least one protected search result. The protected search result can be a search result that contains protected content. The method can further associate the requester with an institution having access rights to the protected search result. Additionally, the method can indicate that the associated institution is authorized to access the protected search result within the search results set.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an embodiment of a system for implementing the invention.

FIG. 2 illustrates an embodiment of a method for identifying and indicating which protected content within a search results set a requester is authorized to access.

FIG. 3 illustrates an embodiment of a UI for informing a user of search results within a search result set that the affiliated institution is and is not authorized to access.

### DETAILED DESCRIPTION

The invention introduces a system and method for allowing requesters to access certain protected electronic content. Such protected content can be provided within search results related to a search request submitted by a requester. The invention can be configured to inform a requester of the protected search results within a search results set that may be protected that the requester does not have access to, and those protected search results the requester is authorized to access. Any type of identifier may be employed within the user interface (UI) of the requester's machine to indicate which search results are accessible and those that are not.

In an embodiment, the invention determines which search results contain protected content and which results contain freely available content. Any institution the requester is affiliated with can also be determined. Based on these affiliated institution, a determination can be made as to whether the affiliated institution is authorized to access any of the protected search results. If the affiliated institution is authorized to access any of the protected search results, the invention can indicate which search results the affiliated institution has access to and which results are protected results that the affiliated institution is not authorized to access.

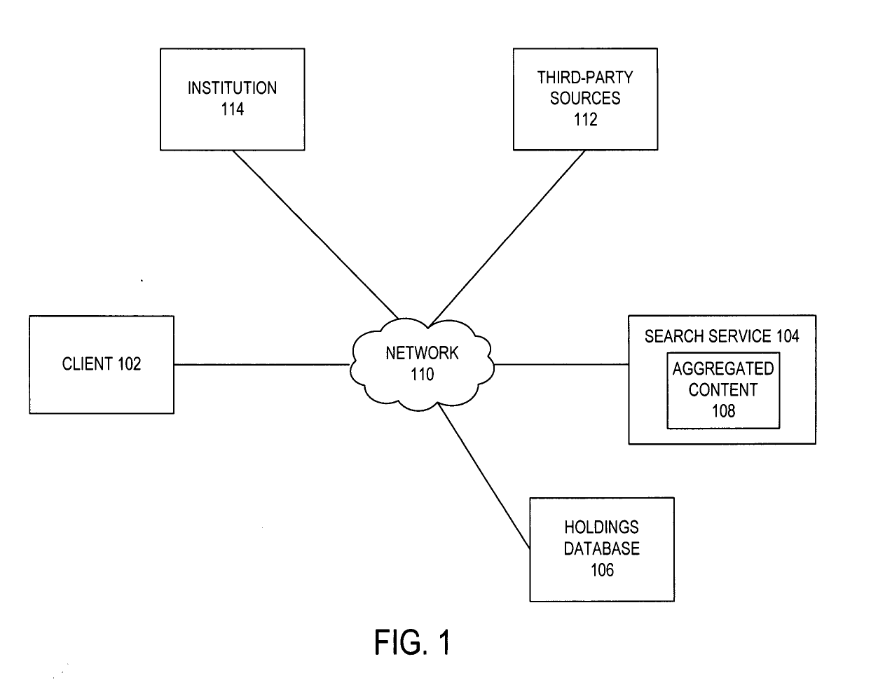

FIG. 1 illustrates an embodiment of a system for implementing the invention. Client 102 may be or include a desktop or laptop computer, a network-enabled cellular telephone (with or without media capturing/playback capabilities), wireless email client, or other client, machine or device to perform various tasks including Web browsing, search, electronic mail (email) and other tasks, applications and functions. Client 102 may additionally be any portable media device such as digital still camera devices, digital video cameras (with or without still image capture functionality), media players such as personal music players and personal video players, and any other portable media device. Client 102 can be used by any user to submit a search request and receive a search results set.

Client 102 can include a communication interface. The communication interface may be an interface that can allow the client to be directly connected to any other client, server, or device or allows the client 102 to be connected to a client, server, or device over network 110. Network 110 can include, for example, a local area network (LAN), a wide area network (WAN), or the Internet. In an embodiment, the client 102 can be connected to another client, device, or server via a wireless interface.

Search service 104, holdings database 106, third-party source 112, and institution 114 can each be a server including a workstation running the Microsoft Windows®, MacOS™, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform. In another embodiment, client 102 may also be a server. Search service 104, holdings database 106, third-party source 112, and institution 114 can also have a communication interface for communicating with one or more devices over network 110.

In an embodiment, search service 104 can be any type of search engine that can index any type of content from a plurality of third-party sources 112. In an embodiment, institution 114 can be an entity that a user has an affiliation with. For example, an institution can be a school, a library, a company, or another entity that a user can be associated with. In an embodiment, search service 104 is an academic search service that aggregates a plurality of academic content from a plurality of third-party sources 112. In such an embodiment a third-party source can be a server or website that includes an academic database for storing academic content. The academic content can be any type of academic-related literature such as, but not limited to, articles, journals, books, term papers, or any other type of published academic literature. The academic content can be aggregated from a plurality of third-party sources and stored in aggregated content database 108. As shown in FIG. 1, aggregated content database 108 is included within search service 104, however, in other embodiments the database may be external to the search service.

In an embodiment, holdings database 106 is utilized to manage the electronic holdings of an institution 114. A particular institution can register with a holdings database in order for the holdings database to manage its electronic holdings. The holdings database can be used to manage any relationships between its registered institutions and any third-party sources that its registered institutions have subscribed to. In managing such relationships, the holdings database can manage the access rights its registered institutions have for accessing content from particular third-party sources.

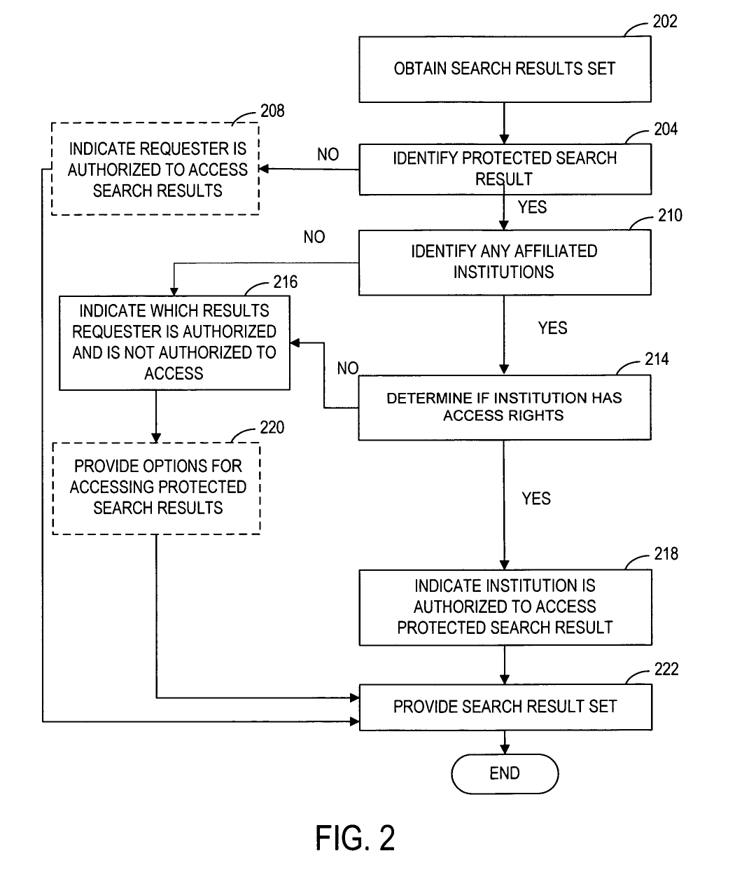

FIG. 2 illustrates an embodiment of a method for identifying and indicating which protected content within a search results set a requester is authorized to access. In response to a requester submitting a search query, at operation 202, a search results set is obtained. At operation 204, protected search results within the search results set are identified. The protected search results can include search results that contain protected content. In an embodiment, protected content can include any type of content that requires a subscription to the particular third-party source that the content originated from. In other embodiments the protected content may also include pay-per-view content that a user may have to pay for in order to access the content. In further embodiments, the protected content can include any type of content protected behind a third-party source's firewall that may require the requester to be authenticated before access rights to the protected content are granted.

In an embodiment, protected search results within the search results set are identified by detecting an identifier that indicates the search result contains protected content. If it is determined that there are no protected search results within the search results set, an indication that the requester is authorized to access the search results within the set can be given within the user interface (UI) of the client at operation 208 along with the search results set at operation 222. In an embodiment, the search results set can be provided without indicating that the requester is authorized to access the search results.

If it is determined that there are one or more protected search results within the set, at operation 210, any institution affiliated with the requester is identified. In an embodiment, an affiliated institution can be identified by detecting any user-initiated preferences that are stored as a cookie on the client of the requester. For example, a requester who may bee a student at a particular institution can select that institution from a list of participating institutions. In such an embodiment, a participating institution can be an institution that has registered with a particular entity. For example, a participating institution can be an institution that has registered with an entity such as the search service 104 (FIG. 1). The selection can then be stored as a cookie on the student's client. In an embodiment, the requester can be associated with multiple institutions by selecting more than one institution and having more than one cookie stored on his/her client.

In another embodiment, an affiliated institution can be identified through an external IP address. For example, the particular entity that an institution is registered with can have a list of the participating institutions' IP addresses and any other IP addresses that are associated with the institutions. The entity can then determine if the IP address of the requester's client matches any IP address found within the list. In still another embodiment, an affiliated institution can be identified if a user has accessed a referral link from a webpage of the institution. A referral link can be a link to the search service that is embedded on a webpage of the institution. The referral link can have embedded in it cookie settings that would automatically associate a requester with that institution once the requester accesses the referral link. For example, if a requester is browsing the webpage of an institution and accesses a referral link to the search service that is on the webpage of the institution, a cookie can be stored on the requester's client to associate the requester with that particular institution. With the cookie, the requester can subsequently be associated with the institution in the future without having to go through the institution. In yet another embodiment, the requester can be associated with multiple institutions by accessing referral links from more than one institution and having more than one cookie stored on his/her client.

If it is determined that the requester is not affiliated with any institutions, at operation 216, an indication is given as to which search results within the search results set the requester is authorized to access and which results the requester is not authorized to access, and the search results set is provided at operation 222. In another embodiment, an indication will be given for only the unauthorized search results. In an embodiment, at operation 220, the requester can be provided with options and alternative methods for accessing the protected search results that the requester is not authorized to access. For example, the requester may be presented with a way to pay for the protected content within the protected search result, a way in order to be affiliated with an authorized institution, or the requester can be provided with information on how to search the Internet for an alternative copy of the protected content.

If it is determined that the requester is affiliated with an institution, at operation 214, a determination is made as to whether the affiliated institution has access rights to the protected search result. In an embodiment, the holdings database of the institution is contacted in order to determine whether the institution has the rights to access the protected search result. In an embodiment, the holdings database is contacted using the NISO Z39.88 OpenURL 1.0 standard. For example, the search service can transmit an OpenURL call of the affiliated institution along with any metadata related to the protected search result to the holdings database of the affiliated institution. In an embodiment, the metadata can be obtained from aggregated content database 108 (FIG. 1). In an embodiment wherein the search service is an academic search service that contains academic literature in its aggregated content database, the metadata can include, for example, the name of a journal, the journal number, particular page numbers, the author, etc. The holdings database can search its memory to find the access rights of the affiliated institution and can transmit a XML construct back to the search service that includes the access rights of the particular affiliated institution.

In an embodiment, if it is determined that the affiliated institution is not authorized to access certain protected search results, at operation 216, an indication can be given to inform the requester which search results within the search results set the requester is and is not authorized to access along with the provided search results set at operation 222. In another embodiment, an indication can be given only for the protected search results that the requester is not authorized to access. In yet another embodiment, at operation 220, the requester can be provided with options and alternative methods for accessing the protected search results that the requester is not authorized to access. In an embodiment, if it is determined that the affiliated institution is authorized to access certain protected search results, at operations 218 and 222, an indication of the protected search results within the search results set that the affiliated institution is authorized to access is provided along with the other search results in the set.

In an embodiment, the search results can be displayed to a requester in a ranked order. The ranked order can be determined by any algorithm employed by the invention. In an embodiment, an algorithm can be configured to display search results that the requester is authorized to access before search results that the requester is not authorized to access. In such an embodiment, the algorithm can be further configured to display search results that are freely available to any requester before protected search results that the requester is authorized to access. However, any algorithm can be employed that can determine the ranking order of search results within a search results set.

There can be a plurality of indications that the invention uses to indicate which search results the affiliated institution has access to and which search results that include protected content that a affiliated institution is not authorized to access. These indications can be visually represented within the UI of the requester's client. In embodiments of the invention, different icons, symbols, colors, text, multimedia content, or any other identifier can be used to distinguish a search result that an affiliated institution has access to versus search results that an affiliated institution does not have access to. Such identifiers may also be used to distinguish protected search results that an affiliated institution is authorized to access, protected search results that an affiliated institution is not authorized to access, and search results that are not protected and are freely available to anyone. In an embodiment, a separate identifier within the UI may also be used to indicate whether a requester would like to receive optional methods for accessing the protected search results that the affiliated institution is not authorized to access.

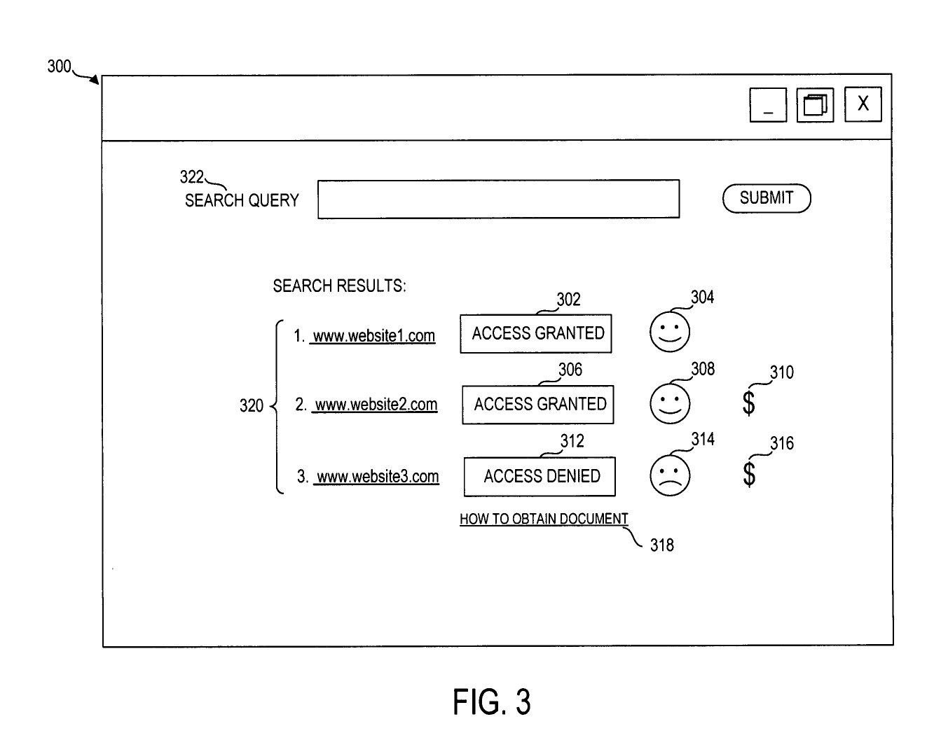

FIG. 3 illustrates an embodiment of a UI for informing a user of search results within a search result set that the affiliated institution is and is not authorized to access. UI 300 can include a search query input field 322 and a search result output area that includes search results set 320. For the first search result, text box 302 is used to indicate that affiliated institution is authorized to access the search result. Icon 304, a smiley face for example, can also be used to indicate that the affiliated institution is authorized to access the first search result. Text box 306 and icon 308, for example, can be used to indicate that the affiliated institution is authorized to access the second search result. Icon 310, for example, can be used to indicate that the particular search result includes protected content that may require a subscription to the third-party source that provided the protected content or that may require a fee payable to the third-party source. Icon 310 is displayed along text box 306 and icon 308 which can inform the requester that his/her affiliated institution has obtained the necessary subscription or has paid the necessary fee. Text box 312 and icon 314, for example, can be used to indicate that the affiliated institution is not authorized to access the third search result. Icon 316, for example, may also be used to indicate that the particular search result includes protected content that may require a subscription to the third-party source that provided the protected content or that may require a fee payable to the third-party source. Link 318, for example, can be an identifier presented to a requester that when accessed provides options and alternative methods for accessing the protected content within the search result that the affiliated institution is not authorized to access. In various embodiments, the alternative methods and options can be displayed in the same browser window as the link, in a separate browser window, in a pop-up window, in a side-pane window, or in a top/bottom-pane window.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

We claim:

1. A method for identifying protected content within a search results set that a requester is authorized to access, comprising:
providing a search results set for a requester, the search results set including at least one protected search result;
associating the requester with an institution having access rights to the protected search result;
indicating the institution is authorized to access the protected search result within the search results set.

2. The method according to claim 1, wherein the institution is determined to have access rights to the protected search result by contacting a holdings database.

3. The method according to claim 1, wherein associating the requester with the institution comprises detecting a cookie that identifies institutions affiliated with the user.

4. The method according to claim 1, wherein associating the requester with the institution comprises comparing an IP address to a list of authorized IP addresses.

5. The method according to claim 1, wherein associating the requester with the institution comprises associating the requester with the institution when the requester accesses a referral link from the webpage of the institution.

6. The method according to claim 5, further comprising storing the requester's association with the institution as a cookie on the requester's machine after the requester accesses the referral link.

7. The method according to claim 6, further comprising identifying that the requester is associated with the institution using the cookie and without having to subsequently access the referral link.

8. The method according to claim 1, wherein the protected search result includes at least one of subscription-based content and pay-per-view content.

9. The method according to claim 1, further comprising providing a first identifier with the protected search result that indicates the institution is authorized to access the protected search result.

10. The method according to claim 9, further comprising providing a second identifier with the protected search result that indicates the institution is not authorized to access the protected search result.

11. The method according to claim 1, further comprising providing a third identifier with the protected search result that indicates the protected search result is protected.

12. A method for identifying protected content within a search results set that a requester is authorized to access, comprising:
aggregating a plurality of academic content into a database, wherein the academic content includes or more items of protected content;
receiving a request for the one or more items of protected content;
providing a search results set, the search results set including the one or more items of protected content;
associating the requester with an institution having access rights to the one or more items of protected content;
indicating the institution is authorized to access the one or more items of protected content within the search results set.

13. The method according to claim 12, wherein the institution is determined to have access rights to the protected search result by contacting a holdings database.

14. The method according to claim 12, wherein associating the requester with the institution comprises comparing an IP address to a list of authorized IP addresses.

15. The method according to claim 12, wherein associating the requester with the institution comprises comparing an IP address to a list of authorized IP addresses

16. The method according to claim 12, wherein associating the requester with the institution comprises associating the requester with the institution when the requester accesses a referral link from the webpage of the institution.

17. A user interface for displaying access rights to a requester, comprising:
a search request input field for receiving an academic search request;
a search result output field for displaying an academic search results set;
a second identifier for indicating which search results within the academic search results set an institution is authorized to access; and
a second identifier for indicating which search results within the academic search results set the institution is not authorized to access.

18. The user interface according to claim 17, further comprising a third identifier for indicating which search results within the academic search results set include protected content.

19. The user interface according to claim 17, further comprising a fourth identifier for displaying at least one method for informing the requester how to obtain access rights for the search results that the institution is not authorized to access.

20. The user interface according to claim 17, wherein the fourth identifier is a link.
